(19) United States
(12) Patent Application Publication
(10) Pub. No.: US 2017/0085790 A1
(43) Pub. Date: Mar. 23, 2017

(54) HIGH-RESOLUTION IMAGING OF REGIONS OF INTEREST

(71) Applicant: Microsoft Technology Licensing, LLC, Redmond, WA (US)

(72) Inventor: David D. Bohn, Fort Collins, CO (US)

(21) Appl. No.: 14/863,235

(22) Filed: Sep. 23, 2015

(51) Int. Cl. H04N 5/232; H04N 5/247; H04N 5/225; H04N 5/235; G06K 9/20; G06K 9/46

(52) U.S. Cl. CPC H04N 5/23235; G06K 9/2054; G06K 9/4604; H04N 5/23216; H04N 5/2256; H04N 5/2354; H04N 5/247

(57) ABSTRACT

Examples are disclosed that relate to obtaining high-resolution images of regions of interest in a physical space. One disclosed example provides an imaging system, comprising a first camera, a second line-scan camera configured to capture a higher-resolution image than the first camera, a logic subsystem, and a storage subsystem. The storage subsystem holds instructions executable by the logic subsystem to, obtain, via the first camera, a lower-resolution image of a physical space, identify one or more regions of interest in the physical space based on the lower-resolution image, and, for each of the one or more regions of interest, obtain, via the second line-scan camera, a higher-resolution image of at least a portion of the region of interest.

### BACKGROUND

High-resolution images may provide a level of detail useful in various applications, including but not limited eye tracking, iris biometrics, facial biometrics, and video conferencing.

### SUMMARY

Examples are disclosed that relate to obtaining high-resolution images of regions of interest in a physical space. One disclosed example provides an imaging system comprising a first camera, a second line-scan camera configured to capture a higher-resolution image than the first camera, a logic subsystem, and a storage subsystem. The storage subsystem holds instructions executable by the logic subsystem to obtain, via the first camera, a lower-resolution image of a physical space, identify one or more regions of interest in the physical space based on the lower-resolution image, and, for each of the one or more regions of interest, obtain, via the second line-scan camera, a higher-resolution image of at least a portion of the region of interest.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example imaging system including a lower-resolution camera and a higher-resolution camera.

FIG. 2 shows an example method for imaging a physical space.

FIG. 3 shows an example image of a physical space.

FIG. 4 shows an example image of a region of interest in the physical space of FIG. 3.

FIG. 5 shows an example scenario in which an imaging system is positioned centrally in a physical space.

FIG. 6 shows an example scenario where an imaging system is positioned adjacent a border of a physical space.

FIG. 7 shows an example computing system.

### DETAILED DESCRIPTION

High-resolution images of relatively large physical spaces, such as conference rooms, may be obtained in various manners. For example, a large two-dimensional image sensor with wide field-of-view optics may be used to image the entire physical space to yield a high-resolution image. However, a suitably large image sensor may be prohibitively expensive for many general purpose applications. Moreover, processing such a high-resolution image, for example, to identify biometric information within the image may pose a significant processing burden.

Accordingly, examples are disclosed that relate to obtaining high-resolution images of a physical space in a manner that conserves computing resources compared to high-resolution imaging of an entire area. Briefly, the disclosed examples relate to identifying regions of interest in the physical space using lower-resolution image data, and obtaining high-resolution images corresponding to each region of interest. By obtaining high-resolution images of the regions of interest in the physical space, while ignoring (or otherwise not obtaining images of) other regions in the physical space that are not of interest, a total amount of image data obtained for processing and analysis may be reduced relative to an approach where a high-resolution image of the entire physical space is obtained.

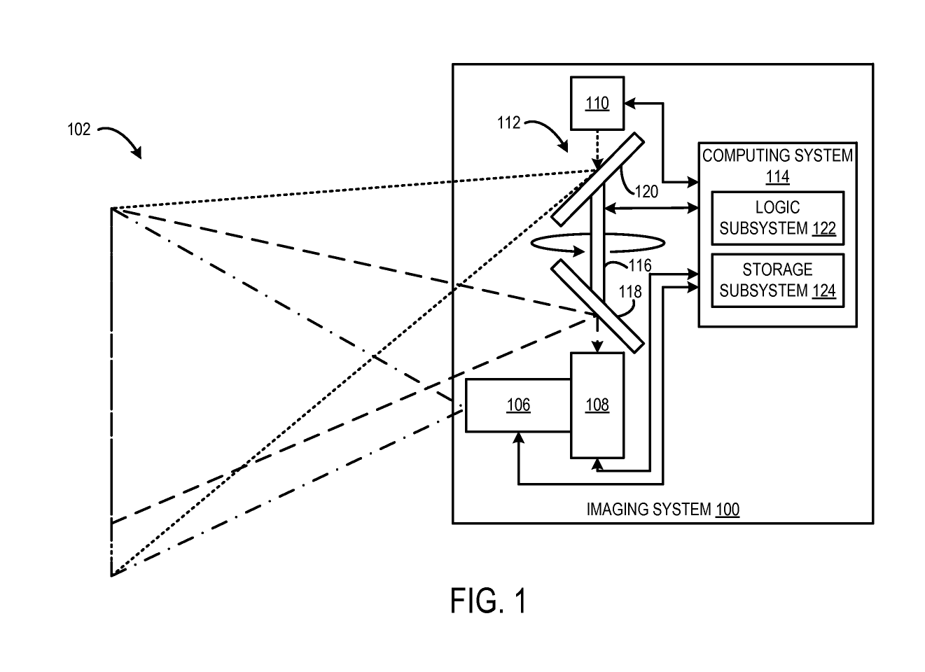

FIG. 1 shows an example imaging system 100 configured to image a physical space 102. The physical space 102 may be of any suitable size and dimension. In one non-limiting example, the physical space 102 may encompass a distance of up to 15 meters away from the image system 100. Such a physical space 102 may represent a meeting room or other large gathering area in which multiple meeting participants may be present. In such an example, the imaging system 100 may provide video conferencing functionality that includes imaging the meeting participants and biometrically identifying the meeting participants based on obtained images.

The image system 100 as depicted includes a lower-resolution camera 106, a higher-resolution camera 108, an illumination source, 110, an optical system 112, and a computing system 114. The lower-resolution camera 106 may be configured to obtain one or more lower-resolution images of the physical space 102 for processing by the computing system 114.

The lower-resolution camera 106 may be any suitable type of camera and may have any suitable resolution lower than that of the higher-resolution camera 108. For example, the lower-resolution camera may have a resolution suitable to provide wide-angle images for processing by the computing system 114 on a frame-by-frame basis to identify various regions of interest in the physical space 102. In one example, the lower-resolution image may have a resolution up to 1920 by 1080 pixels. In various implementations, the lower-resolution camera 106 may include a visible light camera (e.g., an RGB camera), a thermal camera, or an infrared camera. In some implementations, the imaging system 100 may include one or more thermal sensors in addition to or instead of the lower-resolution camera 106. For example, the one or more thermal sensors may be used to identify meeting participants in the physical space 102. Further, in some implementations, the lower-resolution camera 106 may alternately or additionally include a depth camera, such as a time-of-flight depth camera or structured light depth camera. In any of these implementations, the lower-resolution camera 106 may be configured to image a significant portion or an entirety of the physical space 102.

Image data from the lower-resolution camera 106 may be processed by the computing system 114 to identify regions of interest in the physical space 102. The higher-resolution camera 108 then may be used to image the regions of interest to yield one or more higher-resolution images of the physical space 102 for more detailed analysis by the computing system 114. It will be understood that the terms “higher-resolution” and “lower-resolution” refer to resolutions of the cameras relative to one another. Limiting the higher-resolution images provided to the computing system 114 to the regions of interest may reduce an amount of image data for analysis (e.g., for facial recognition, gaze tracking, and/or other tasks) compared to providing a higher-resolution image of the entire physical space 102.

Any suitable type of camera may be used as the higher-resolution camera 108. In some implementations, the higher-resolution camera 108 comprises a line-scan camera, and may be configured to image visible or infrared wavelengths. As a non-limiting example, the higher-resolution camera 108 may include a visible light line-scan camera with a resolution of up to 16,000 pixels operating at a 72 kHz line rate. Higher resolutions may be used in other examples.

The optical system 112 includes a rotating shaft 116 and a mirror 118 that is coupled to the rotating shaft 116. The mirror 118 may be configured to reflect a scene toward the higher-resolution camera 108 for imaging. For example, the higher-resolution camera 108 may be oriented vertically relative to the physical space 102 (e.g., pointed at a ceiling), and the mirror 118 may be angled to direct an image toward the image sensor of the higher-resolution camera. In this configuration, a field of view that is reflected by the mirror 118 to the higher-resolution camera 108 extends horizontally out into the physical space 102 relative to the orientation of the higher-resolution camera 108. The rotating shaft 116 may rotate the mirror 118 360-degrees to allow the higher-resolution camera 108 to image a desired region of the physical space 102. In other implementations, a line scan camera may be coupled directly to a rotating shaft.

In some implementations, the rotating shaft 116 may rotate at a constant speed, while in other implementations, the computing system 114 may vary the speed of the rotating shaft 116. As described in more detail, various imaging parameters, such as a sampling rate, may be varied for different regions of interest. Where the rotating shaft rotates at a constant speed, a sampling rate of the higher-resolution camera 108 may be adjusted by adjusting a frame rate of the higher-resolution camera for different regions of interest. Likewise, where the rotational velocity of the rotating shaft is controllable, a similar effect may be achieved by adjusting the rotational velocity of the shaft for different regions of interest.

The illumination source 110 may provide illumination light, such as infrared light, to illuminate a region of interest, for example, while the region of interest is being imaged by the higher-resolution camera 108. In some implementations, the computing system 114 may be configured to adjust one or more illumination parameters of the illumination source 110, such as a light intensity of the illumination source. The computing system 114 also may be configured to selectively switch the illumination source on/off to provide selective illumination light, such that illumination is provided while imaging regions of interest and otherwise not provided.

In the depicted example, a second mirror 120 is positioned on the rotating shaft 116 in a similar or same orientation as mirror 118 to direct illumination light toward a field of view being imaged by the higher-resolution camera 108. In other implementations, the illumination source 110 may be coupled to a separate adjustment mechanism to allow for independent adjustment of a position of the illumination source 110. For example, the illumination source 110 may be coupled to a pan/tilt mechanism.

In some implementations, the optical system 112 may include one or more additional mirrors configured to allow the lower-resolution camera 106 to image the physical space 102 in 360 degrees. In other implementations, the imaging system 100 may include a plurality of lower-resolution cameras aimed in different directions, and the plurality of lower-resolution cameras may collectively image the physical space 102.

Additionally, in some implementations, the lower-resolution camera 106 may be omitted from the imaging system 100, and the higher-resolution camera 108 may be used obtain a lower-resolution, large field-of-view image of the physical space 102 in addition to higher resolution images of regions of interest in the physical space 102. For example, the computing system 114 may periodically obtain, via the higher-resolution camera 108, a down-sampled image of a large portion or an entirety of physical space 102 for the identification of regions of interest. Higher-resolution images may then be obtained for each region of interest.

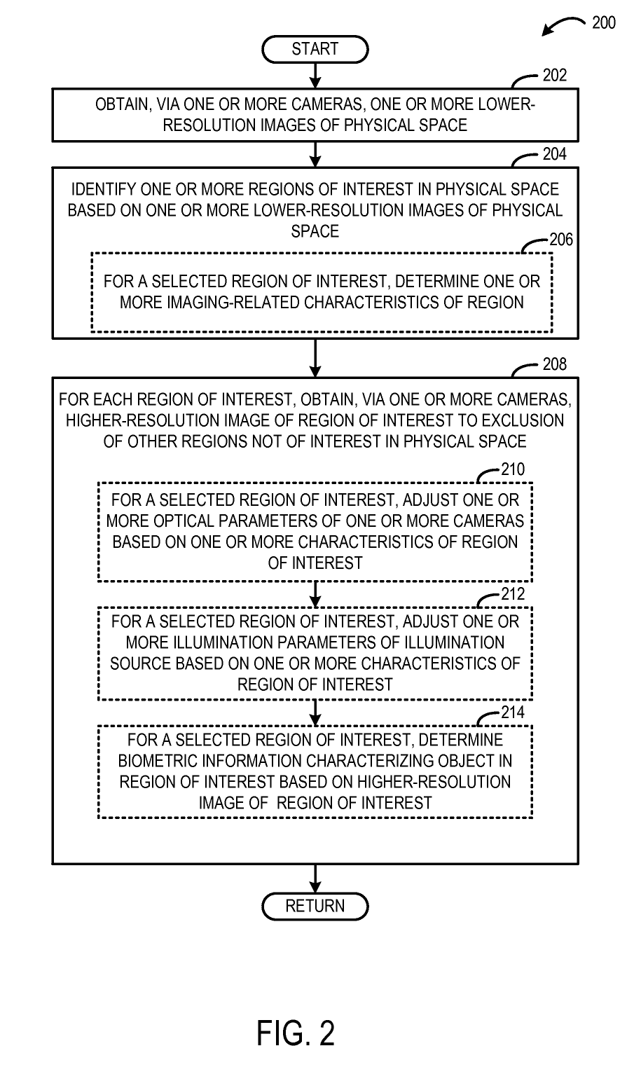

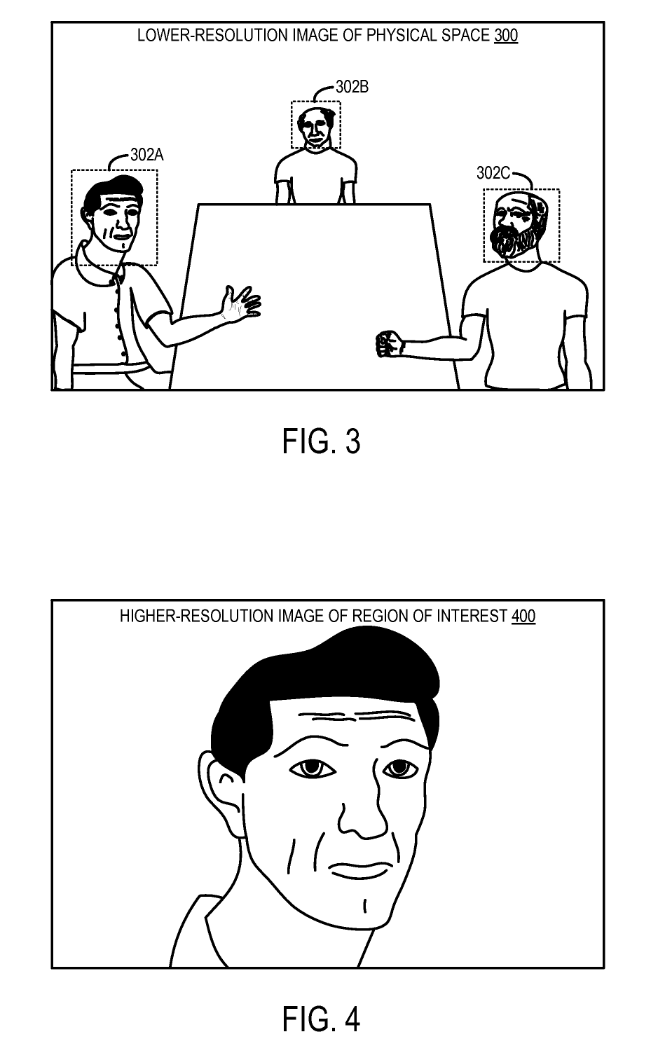

FIG. 2 shows an example method 200 for imaging a physical space that may be performed, for example, via imaging system 100. FIGS. 3-4 show various example images of a physical space that may be obtained in the course of performing method 200, and are referenced in the discussion of method 200.

At 202, method 200 includes obtaining, via one or more cameras, one or more lower-resolution images of the physical space. In some implementations, the one or more lower-resolution images of the physical space may be obtained via the lower-resolution camera 106 of FIG. 1, or may be obtained via performing a lower resolution scan (e.g. by down-sampling) using the higher resolution camera 108. At 204, method 200 includes identifying one or more regions of interest in the physical space based on the one or more lower-resolution images of the physical space. As used herein, a region of interest means any portion of the physical space identified for selective higher-resolution imaging. A region of interest may be identified in any suitable manner. Example approaches for identifying a region of interest in the one or more lower-resolution images of the physical space include applying one or more filters to the one or more images, applying one or more color recognition algorithms to the one or more images, applying one or more thermal recognition algorithms, applying one or more pattern recognition algorithms to the one or more images, applying one or more machine-learning algorithms to the one or more images, and performing other suitable identification operations.

In some implementations, the one or more regions of interest may be identified based at least in part on depth information of the physical space. In some implementations, the depth information may be provided by a depth camera utilized as the lower-resolution camera. For example, a region of interest may correspond to a human subject identified via application of classification methods to the depth data. In some implementations, the one or more regions of interest may be identified based at least in part on thermal information of the physical space. For example, the thermal information may be provided by a thermal camera utilized as the lower-resolution camera.

FIG. 3 shows an example image 300 of a physical space, for example, as obtained via the lower-resolution camera 106 of FIG. 1. The image 300 depicts three meeting participants seated at a conference table. The image 300 may be analyzed to identify a plurality of regions of interest 302 (e.g., 302A, 302B, 302C) in the image 300. In this example, a facial recognition algorithm may be applied to the image 300 in order to identify regions of interest 302 corresponding to the faces of the meeting participants.

Referring again to FIG. 2, information obtained from the lower-resolution image data also may be used to adjust parameters for acquiring the higher-resolution image data of the regions of interest. As such, method 200 may include, for one or more selected regions of interest, determining one or more imaging-related characteristics of the region of interest, such as characteristics that may affect settings for illumination and/or image acquisition, as indicated at 206. Any suitable characteristic of a region of interest may be determined. For example, a depth of a region of interest may be used to adjust an optical system focus for that region of interest. In some implementations, depth information may be determined from a depth image of the physical space obtained via a depth camera, e.g. during a lower-resolution scan. In other examples, depth information for the region of interest may be inferred based on a size of the region of interest and/or an object in the region of interest. As a more specific example, in FIG. 3, a distance between the camera and the meeting participant corresponding to the region of interest 302B may be inferred by comparing the meeting participant's head size in the image 300 to an expected average human head size at a known distance. Other characteristics that may be determined include brightness information for a region of interest, color information for a region of interest, contrast information for a region of interest, and thermal information for a region of interest.

Returning to FIG. 2, once the one or more regions of interest have been identified, method 200 includes, at 208, obtaining, via a higher-resolution camera, a higher-resolution image of each region of interest to the exclusion of other regions. Excluding image data from regions outside of the regions of interest may help to avoid performing complex analyses of portions of the physical scene that do not contain objects of interest, and thus may help to conserve computing resources.

Further, at 210, method 200 may include, for one or more selected regions of interest, adjusting one or more optical parameters of one or more cameras based on the one or more characteristics of the region of interest. Any suitable optical parameter of a camera may be adjusted based on the one or more characteristics of the region of interest, including but not limited to a focus length, a zoom level, an f-number, and a sampling rate. As one example, referring again to FIG. 3, the region of interest 302A may have a depth value that is less than a depth value of the region of interest 302B. Accordingly, a focal length for imaging region of interest 302A may be less than a focal length for imaging region of interest 302B. In another example, the zoom level may be increased for region of interest 302B compared to region of interest 302A to similarly frame an object (e.g. a face) in each region of interest. In yet another example, a sampling rate of the camera may be reduced when capturing the image of the region of interest 302A, and increased when capturing the image of the region of interest 302B. For example, the sampling rate may be down-sampled for the region of interest 302A, as the features of the human face in the image of region of interest 302A may be more easily recognizable due to the shorter distance to the camera. Additionally, one or more optical parameters of the higher-resolution camera may be adjusted to enhance a higher-resolution image in order to perform biometric analysis. For example, if gaze tracking is performed, then one or more optical parameters of the higher-resolution camera may be tuned to highlight the eyes of the human face in the higher-resolution image.

Returning to FIG. 2, at 212, method 200 further may include, for one or more selected regions of interest, adjusting one or more illumination parameters of an illumination source based on the one or more characteristics of the region of interest. Any suitable illumination parameter of the illumination source may be adjusted based on the one or more characteristics of the region of interest. Non-limiting example illumination parameters include a brightness level, an illumination direction, and an on/off state.

Adjusting the one or more illumination parameters of the illumination source may include, for example turning the illumination source on while the camera is capturing a higher-resolution image of the current region of interest, and off while moving between different regions of interest. Referring to imaging system 100 of FIG. 1, the illumination source 110 may be turned off while the mirror 118 rotating between regions of interest, and may be turned on in response to the mirror 118 arriving at the next region of interest.

In some instances, adjustments to the optical parameters and/or the illumination parameters for different regions of interest may be made in a same scan of the higher-resolution line-scan camera, depending upon whether the parameters can be adjusted with sufficient speed. In other instances, adjustments to the optical parameters and/or the illumination parameters may be made in different scans, for example, where the parameters cannot be adjusted quickly enough between regions of interest, or where two regions of interest are located in overlapping areas from the camera perspective (e.g., where one meeting room participant is seated behind another from the perspective of the camera).

At 214, method 200 may include, for one or more selected regions of interest, determining biometric information characterizing an object in the region of interest based on the one or more higher-resolution images of the region of interest. Examples of biometric information that may be determined include face information, eye information, and iris information. Such biometric information may be used to perform various biometric analysis, such as facial recognition, eye tracking, and biometric identification.

FIG. 4 shows an example higher-resolution image 400 of the region of interest 302A shown in FIG. 3 that may be used for biometric analysis. The higher-resolution image 400 includes a human face, and thus may be used to perform facial recognition, eye tracking, and other face-based biometric analysis on aspects of the imaged human face. Such biometric information may be used, for example, to identify and register/label the meeting participants. Moreover, the biometric information may be used to subsequently track a position of the identified meeting participants in the physical space over time.

By obtaining higher-resolution images of the regions of interest to the exclusion of other regions in the physical space that are not of interest, a total amount of image data obtained for processing and analysis may be reduced relative to an approach where a higher-resolution image of the entire physical space is obtained. This may help to reduce computing resources utilized in biometric identification and subsequent motion tracking, and thus may help to facilitate performing such tasks in a relatively large, multi-user environment such as a meeting room.

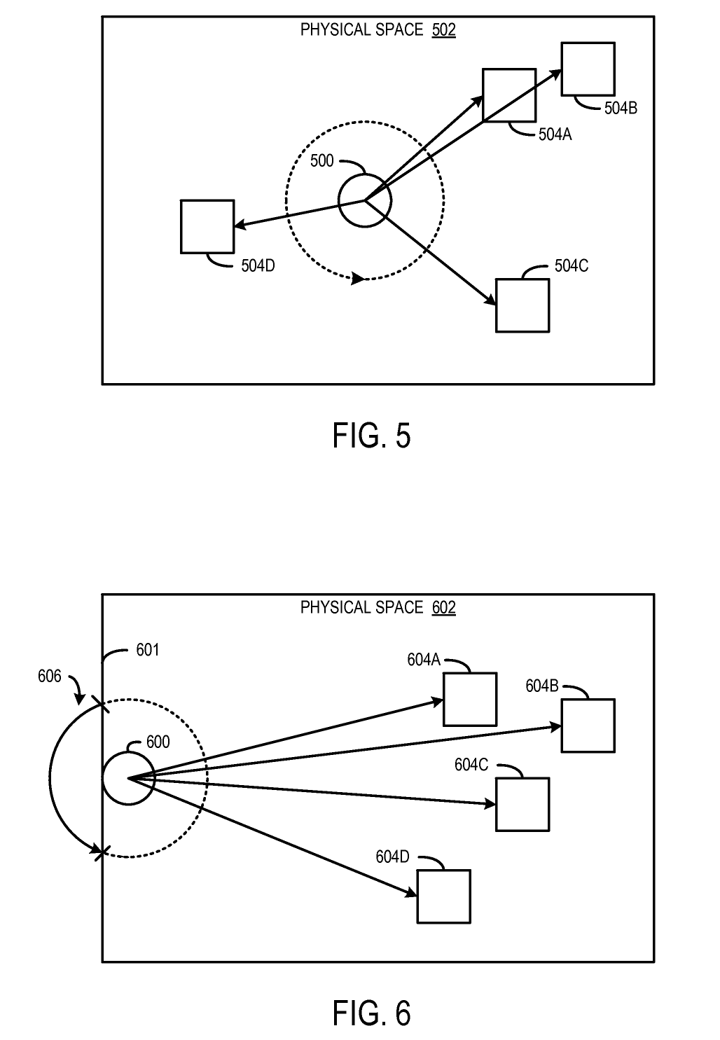

FIG. 5 shows an example scenario in which an imaging system 500 is positioned centrally in a physical space 502 (e.g., a conference room) to obtain images of a plurality of regions of interest 504 (e.g., 504A, 504B, 504C, 504D) in the physical space 502. In this scenario, the imaging system 500 images a 360-degree view of the physical space 502 via one or more lower-resolution cameras arranged to capture a 360-degree view. The one or more lower-resolution images of the physical space 502 that are obtained may be analyzed by the imaging system 500 to identify the regions of interest. Then, the imaging system 500 may obtain a higher-resolution image for each region of interest using a higher-resolution, line-scan camera.

As discussed above, the imaging system 500 further may adjust optical and illumination parameters for the higher-resolution image acquisition process differently for each region of interest. In FIG. 5, it can be seen that regions of interest 504A and 504B are at similar radial angles but different distances from the imaging system 500. As such, the person in region of interest 504A and 504B are imaged at overlapping angles in the radial path of the line scan camera. In view of the different depths, the optical and illumination parameters may be adjusted differently in different passes of the line scan camera for these regions of interest. For example, the imaging system 500 may adjust the higher-resolution, line-scan camera to have relatively less zoom and a shorter focal length in a first pass to obtain a higher-resolution image of region of interest 504A. Then, in another pass, the zoom and focal length may be increased to obtain a higher-resolution image for the region of interest 504B. Illumination, f-number, sample rate, and other parameters also may be adjusted in different passes of the line scan camera for these regions. As regions of interest 504C and 504D are not in overlapping angular ranges, adjustments of optical parameters for regions of interest 504C and 504D may be made either on a same pass or a different pass of the imaging system 500, depending at least in part upon whether the adjustments may be made quickly enough.

FIG. 6 shows an example scenario in which an imaging system 600 is positioned adjacent a border 601 (e.g., a wall) of a physical space 602 to image a plurality of regions of interest 604A, 604B, 604C, 604D in the physical space 602. Where a 360-degree rotating imaging system is employed in this scenario, the imaging system 600 may ignore image data capturing region 606. The imaging system 600 otherwise may obtain higher-resolution images for the plurality of regions of interest 604 in the manner described above with reference to the scenario described with reference to FIG. 5.

In some implementations, the methods and processes described herein may be tied to a computing system of one or more computing devices. In particular, such methods and processes may be implemented as a computer-application program or service, an application-programming interface (API), a library, and/or other computer-program product.

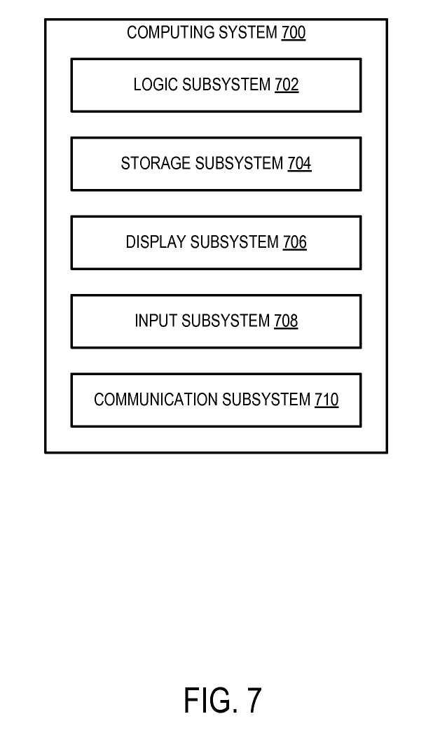

FIG. 7 schematically shows a non-limiting implementation of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices. For example, computing system 700 may correspond to the imaging system 100 of FIG. 1, the imaging system 500 of FIG. 5, and the imaging system 600 of FIG. 6.

Computing system 700 includes a logic subsystem 702 and a storage subsystem 704. Computing system 700 may optionally include a display subsystem 706, input subsystem 708, communication subsystem 710, and/or other components not shown in FIG. 7.

Logic subsystem 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem 702 may include one or more processors configured to execute software instructions. Additionally or alternatively, the logic subsystem 702 may include one or more hardware or firmware logic machines configured to execute hardware or firmware instructions. Processors of the logic subsystem 702 may be single-core or multi-core, and the instructions executed thereon may be configured for sequential, parallel, and/or distributed processing. Individual components of the logic subsystem 702 optionally may be distributed among two or more separate devices, which may be remotely located and/or configured for coordinated processing. Aspects of the logic subsystem 702 may be virtualized and executed by remotely accessible, networked computing devices configured in a cloud-computing configuration.

Storage subsystem 704 includes one or more physical devices configured to hold instructions executable by the logic subsystem 702 to implement the methods and processes described herein. When such methods and processes are implemented, the state of storage subsystem 704 may be transformed—e.g., to hold different data.

Storage subsystem 704 may include removable and/or built-in devices. Storage subsystem 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 704 may include volatile, nonvolatile, dynamic, static, read/write, read-only, random-access, sequential-access, location-addressable, file-addressable, and/or content-addressable devices.

It will be appreciated that storage subsystem 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 702 and storage subsystem 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 706 may be used to present a visual representation of data held by storage subsystem 704. This visual representation may take the form of a graphical user interface (GUI). As the herein described methods and processes change the data held by the storage subsystem 704, and thus transform the state of the storage subsystem 704, the state of display subsystem 706 may likewise be transformed to visually represent changes in the underlying data. Display subsystem 706 may include one or more display devices utilizing virtually any type of technology. Such display devices may be combined with logic subsystem 702 and/or storage subsystem 704 in a shared enclosure, or such display devices may be peripheral display devices.

When included, input subsystem 708 may comprise or interface with one or more user-input devices such as a keyboard, mouse, touch screen, or game controller. In some implementations, the input subsystem 708 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem 710 may be configured for communication via a wireless telephone network, or a wired or wireless local- or wide-area network. In some implementations, the communication subsystem 710 may allow computing system 700 to send and/or receive messages to and/or from other devices via a network such as the Internet.

In another example implementation, an imaging system comprises a first camera, a second line-scan camera configured to capture a higher-resolution image than the first camera, a logic subsystem, and a storage subsystem holding instructions executable by the logic subsystem to obtain, via the first camera, a lower-resolution image of a physical space, identify one or more regions of interest in the physical space based on the lower-resolution image, and for each of the one or more regions of interest, obtain, via the second line-scan camera, a higher-resolution image of at least a portion of the region of interest. In one example implementation that optionally may be combined with any of the features described herein, the storage subsystem further holds instructions executable by the logic subsystem to for each region of interest of the one or more regions of interest, determine one or more characteristics of the region of interest based on the lower-resolution image of the physical space, and adjust one or more optical parameters of the second line-scan camera based on the one or more characteristics of the region of interest. In one example implementation that optionally may be combined with any of the features described herein, the one or more characteristics includes a distance of the region of interest from the first camera. In one example implementation that optionally may be combined with any of the features described herein, the one or more optical parameters include one or more of a focus length, a zoom level, an f-number, and a sampling rate. In one example implementation that optionally may be combined with any of the features described herein, the imaging system further comprises an illumination source, and the storage subsystem further holds instructions executable by the logic subsystem to, adjust one or more illumination parameters of the illumination source based on the one or more characteristics of the region of interest. In one example implementation that optionally may be combined with any of the features described herein, the storage subsystem further holds instructions executable by the logic subsystem to for each of the one or more regions of interest, determine biometric information characterizing an object in the region of interest based on the higher-resolution image of the at least a portion of the region of interest. In one example implementation that optionally may be combined with any of the features described herein, the first camera is a thermal camera. In one example implementation that optionally may be combined with any of the features described herein, the first camera is a depth camera. In one example implementation that optionally may be combined with any of the features described herein, the first camera is a visible light camera.

In another example implementation, on an imaging system, a method for imaging a physical space comprises obtaining, via one or more cameras, an image of the physical space, identifying a plurality of regions of interest in the physical space based on the image of the physical space, for each region of interest of the plurality of regions of interest, determining one or more characteristics of the region of interest based on the image of the physical space, adjusting one or more optical parameters of the one or more cameras based on the one or more characteristics of the region of interest, and obtaining, via the one or more cameras, an image of at least a portion of the region of interest to the exclusion of another region. In one example implementation that optionally may be combined with any of the features described herein, the one or more optical parameters include one or more of a focus length, a zoom level, an f-number, and a sampling rate. In one example implementation that optionally may be combined with any of the features described herein, the one or more characteristics includes a distance of the region of interest from the lower-resolution camera. In one example implementation that optionally may be combined with any of the features described herein, the imaging system includes an illumination source, and the method further comprises, for each region of interest of the plurality of regions of interest, adjusting one or more illumination parameters of the illumination source based on the one or more characteristics of the region of interest. In one example implementation that optionally may be combined with any of the features described herein, the one or more cameras include a first camera and a second line-scan camera configured to capture a higher-resolution image than the first camera, the image of the physical space is obtained via the first camera, the one or more optical parameters of the second line-scan camera are adjusted based on the one or more characteristics of the region of interest, and the image of the at least a portion of the region of interest is obtained via the second line-scan camera. In one example implementation that optionally may be combined with any of the features described herein, the one or more cameras includes a single higher-resolution, line-scan camera, obtaining the image of the physical space includes processing pixel information from the single higher-resolution, line-scan camera corresponding to the physical space, and for each region of interest, obtaining an image of at least a portion of the region of interest includes processing pixel information from the single higher-resolution, line-scan camera corresponding to the at least the portion of the region of interest, and ignoring pixel information from the single higher-resolution, line-scan camera corresponding to a region outside the region of interest.

In another example implementation, an imaging system comprises a first camera, a second line-scan camera configured to capture a higher-resolution image than the first camera, a logic subsystem, and a storage subsystem holding instructions executable by the logic subsystem to obtain, via the first camera, a lower-resolution image of a physical space, identify a plurality of regions of interest in the physical space based on the lower-resolution image, for each region of interest of the plurality of regions of interest, determine one or more characteristics of the region of interest based on the lower-resolution image of the physical space, adjust one or more optical parameters of the second line-scan camera based on the one or more characteristics of the region of interest, and obtain, via the second line-scan camera, an image of at least a portion of the region of interest to the exclusion of another region. In one example implementation that optionally may be combined with any of the features described herein, the one or more characteristics includes a distance of the region of interest from the first camera. In one example implementation that optionally may be combined with any of the features described herein, the one or more optical parameters include one or more of a focus length, a zoom level, an f-number, and a sampling rate. In one example implementation that optionally may be combined with any of the features described herein, the imaging system further comprises an illumination source, and the storage subsystem further holds instructions executable by the logic subsystem to adjust one or more illumination parameters of the illumination source based on the one or more characteristics of the region of interest. In one example implementation that optionally may be combined with any of the features described herein, the storage subsystem further holds instructions executable by the logic subsystem to, for each of the one or more regions of interest, determine biometric information characterizing an object in the region of interest based on the higher-resolution image of the at least a portion of the region of interest.

It will be understood that the configurations and/or approaches described herein are exemplary in nature, and that these specific implementations or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An imaging system, comprising:
a first camera;
a second line-scan camera configured to capture a higher-resolution image than the first camera;
a logic subsystem; and
a storage subsystem holding instructions executable by the logic subsystem to:
obtain, via the first camera, a lower-resolution image of a physical space;
identify one or more regions of interest in the physical space based on the lower-resolution image; and
for each of the one or more regions of interest, obtain, via the second line-scan camera, a higher-resolution image of at least a portion of the region of interest.

2. The imaging system of claim 1, wherein the storage subsystem further holds instructions executable by the logic subsystem to:
for each region of interest of the one or more regions of interest,
determine one or more characteristics of the region of interest based on the lower-resolution image of the physical space; and
adjust one or more optical parameters of the second line-scan camera based on the one or more characteristics of the region of interest.

3. The imaging system of claim 2, wherein the one or more characteristics includes a distance of the region of interest from the first camera.

4. The imaging system of claim 2, wherein the one or more optical parameters include one or more of a focus length, a zoom level, an f-number, and a sampling rate.

5. The imaging system of claim 2, further comprising an illumination source, and
wherein the storage subsystem further holds instructions executable by the logic subsystem to, adjust one or more illumination parameters of the illumination source based on the one or more characteristics of the region of interest.

6. The imaging system of claim 1, wherein the storage subsystem further holds instructions executable by the logic subsystem to:
for each of the one or more regions of interest, determine biometric information characterizing an object in the region of interest based on the higher-resolution image of the at least a portion of the region of interest.

7. The imaging system of claim 1, wherein the first camera is a thermal camera.

8. The imaging system of claim 1, wherein the first camera is a depth camera.

9. The imaging system of claim 1, wherein the first camera is a visible light camera.

10. On an imaging system, a method for imaging a physical space, the method comprising:
obtaining, via one or more cameras, an image of the physical space;
identifying a plurality of regions of interest in the physical space based on the image of the physical space;
for each region of interest of the plurality of regions of interest,
determining one or more characteristics of the region of interest based on the image of the physical space;
adjusting one or more optical parameters of the one or more cameras based on the one or more characteristics of the region of interest; and
obtaining, via the one or more cameras, an image of at least a portion of the region of interest to the exclusion of another region.

11. The method of claim 10, wherein the one or more optical parameters include one or more of a focus length, a zoom level, an f-number, and a sampling rate.

12. The method of claim 10, wherein the one or more characteristics includes a distance of the region of interest from the lower-resolution camera.

13. The method of claim 10, wherein the imaging system includes an illumination source, and wherein the method further comprises, for each region of interest of the plurality of regions of interest, adjusting one or more illumination parameters of the illumination source based on the one or more characteristics of the region of interest.

14. The method of claim 11, wherein the one or more cameras include a first camera and a second line-scan camera configured to capture a higher-resolution image than the first camera, wherein the image of the physical space is obtained via the first camera, wherein the one or more optical parameters of the second line-scan camera are adjusted based on the one or more characteristics of the region of interest, and wherein the image of the at least a portion of the region of interest is obtained via the second line-scan camera.

15. The method of claim 11, wherein the one or more cameras includes a single higher-resolution, line-scan camera, wherein obtaining the image of the physical space includes processing pixel information from the single higher-resolution, line-scan camera corresponding to the physical space, and wherein for each region of interest, obtaining an image of at least a portion of the region of interest includes processing pixel information from the single higher-resolution, line-scan camera corresponding to the at least the portion of the region of interest, and ignoring pixel information from the single higher-resolution, line-scan camera corresponding to a region outside the region of interest.

16. An imaging system, comprising:
a first camera;
a second line-scan camera configured to capture a higher-resolution image than the first camera;
a logic subsystem; and
a storage subsystem holding instructions executable by the logic subsystem to:
obtain, via the first camera, a lower-resolution image of a physical space;
identify a plurality of regions of interest in the physical space based on the lower-resolution image;
for each region of interest of the plurality of regions of interest,
determine one or more characteristics of the region of interest based on the lower-resolution image of the physical space;
adjust one or more optical parameters of the second line-scan camera based on the one or more characteristics of the region of interest; and
obtain, via the second line-scan camera, an image of at least a portion of the region of interest to the exclusion of another region.

17. The imaging system of claim 16, wherein the one or more characteristics includes a distance of the region of interest from the first camera.

18. The imaging system of claim 16, wherein the one or more optical parameters include one or more of a focus length, a zoom level, an f-number, and a sampling rate.

19. The imaging system of claim 16, further comprising an illumination source, and wherein the storage subsystem further holds instructions executable by the logic subsystem to, adjust one or more illumination parameters of the illumination source based on the one or more characteristics of the region of interest.

20. The imaging system of claim 16, wherein the storage subsystem further holds instructions executable by the logic subsystem to,
for each of the one or more regions of interest, determine biometric information characterizing an object in the region of interest based on the higher-resolution image of the at least a portion of the region of interest.
